(19) United States
(12) Patent Application Publication
(10) Pub. No.: US 2011/0109453 A1
(43) Pub. Date: May 12, 2011

(54) Apparatus for Warning of an Expiration Date

(76) Inventor: Chia-Wen Chen, Taichung City (TW)

(21) Appl. No.: 12/877,556

(22) Filed: Sep. 8, 2010

(30) Foreign Application Priority Data
Nov. 10, 2009 (TW) 098220805
Nov. 10, 2009 (TW) 098220807

(51) Int. Cl. G08B 21/00

(52) U.S. Cl. 340/540

(57) ABSTRACT

An apparatus for warning of an expiration date includes a casing, a processing unit located in the casing, and an attachment unit connected to the casing. The processing unit includes a power supply unit, a switch and a warning unit electrically connected to one another. The warning unit warns a user of the expiration date of an object when the expiration date is reached. The attachment unit is connected to the casing. The attachment unit can be detachably attached to the object.

### BACKGROUND OF INVENTION

1. Field of Invention

The present invention relates to an apparatus for warning of an expiration date.

2. Related Prior Art

As disclosed in Taiwanese Patent No. M349533, a conventional apparatus for warning of an expiration date for a storage apparatus includes a processing unit, a power supply unit, an operation unit, a display unit, a switch unit and a warning unit. The expiration date of food can be set, and countdown can be executed, and sound and light are given to remind a user of handling the food to avoid others from eating the food that has expired. This conventional apparatus can only be used in some places in the storage apparatus such as in a bucket in a refrigerator or on a door of the refrigerator. There are often various pieces of food in the bucket or the refrigerator. The expiration dates of the various pieces of food are different. The user will not know exactly what piece of food is due when he or she receives warning from this conventional apparatus. The user might have to dump all of the food to ensure that no one eats any rotten food. This would be a waste.

As disclosed in Taiwanese Patent No. M364197, an RFID smart refrigerator includes electronic labels, a writer/reader and an interface. The electronic labels can be attached to clips, cups, bowls, plates, pods, kettles, bottles, bags and the like. The writer/reader is located in the refrigerator for writing and reading the electronic labels via the radio frequency. The interface is located on the refrigerator and electrically connected to the writer/reader. The interface includes a microcomputer, an input unit and an output unit. The input unit is operable to instruct the writer/reader to write data into the electronic labels. The data written in the electronic labels are read by the writer/reader and shown on the output unit. The input unit is a keypad and the output unit is a display for example. Alternatively, the input and output units are integrated in a touch panel. However, the electronic labels, the writer/reader and the interface must be used in a same refrigerator to warn a user of expiration dates of food to prevent someone from eating any of the food that is overdue. The electronic labels cannot be used to provide any warning if they are located in any other refrigerators by mistake. Hence, such an electronic label cannot specifically be used for a certain piece of food.

The present invention is therefore intended to obviate or at least alleviate the problems encountered in prior art.

### SUMMARY OF INVENTION

It is the primary objective of the present invention to provide a convenient apparatus for warning of expiration dates.

To achieve the foregoing objective, the apparatus for warning of an expiration date includes a casing, a processing unit located in the casing, and an attachment unit connected to the casing. The processing unit includes a power supply unit, a switch and a warning unit electrically connected to one another. The warning unit warns a user of the expiration date of an object when the expiration date is reached. The attachment unit is connected to the casing. The attachment unit can be detachably attached to the object.

Other objectives, advantages and features of the present invention will be apparent from the following description referring to the attached drawings.

### BRIEF DESCRIPTION OF DRAWINGS

The present invention will be described via detailed illustration of several embodiments referring to the drawings wherein:

FIG. 1 is a perspective view of an apparatus for warning of an expiration date according to a first embodiment of the present invention;

FIG. 2 is an exploded view of the apparatus for warning of an expiration date shown in FIG. 1;

FIG. 3 is a perspective view of a bag used with the apparatus for warning of an expiration date shown in FIG. 1;

FIG. 4 is a refrigerator containing the bag and the apparatus for warning of an expiration date shown in FIG. 3;

FIG. 5 is a perspective view of an apparatus for warning of an expiration date according to a second embodiment of the present invention;

FIG. 6 is a perspective view of a case used with the apparatus for warning of an expiration date shown in FIG. 5;

FIG. 7 is a perspective view of an apparatus for warning of an expiration date according to a third embodiment of the present invention;

FIG. 8 is a perspective view of a case used with the apparatus for warning of an expiration date shown in FIG. 7;

FIG. 9 is a perspective view of an apparatus for warning of an expiration date according to a fourth embodiment of the present invention;

FIG. 10 is an exploded view of the apparatus for warning of an expiration date shown in FIG. 9;

FIG. 11 is a cross-sectional view of the apparatus for warning of an expiration date shown in FIG. 10;

FIG. 12 is a perspective view of a refrigerator containing a bag used with the apparatus for warning of an expiration date shown in FIG. 9;

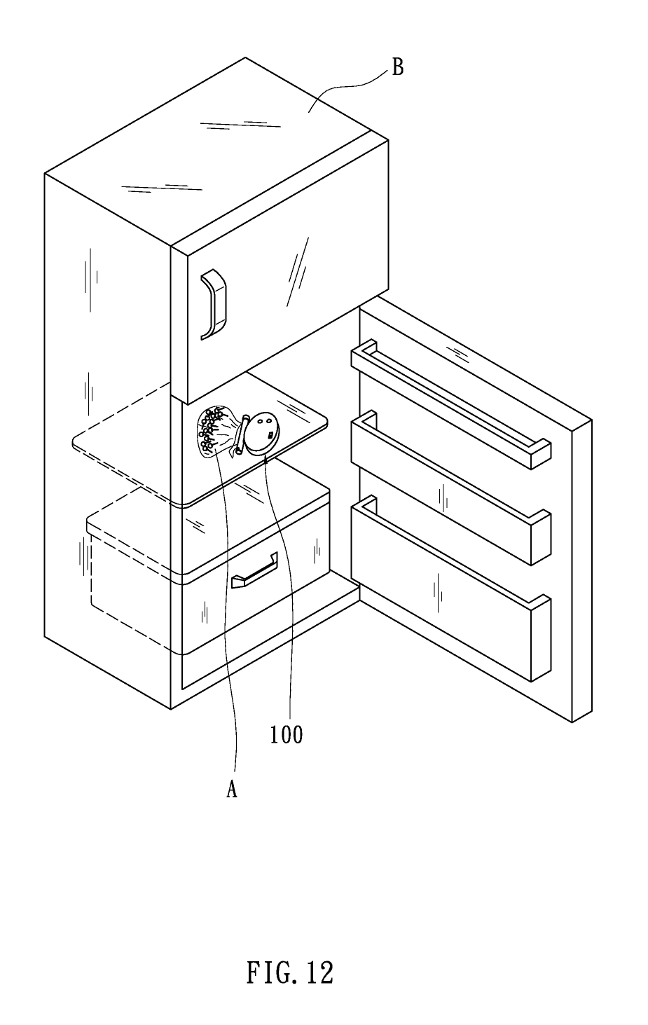

FIG. 13 is a cross-sectional view of an apparatus for warning of an expiration date according to a fifth embodiment of the present invention;

FIG. 14 is a cross-sectional view of an apparatus for warning of an expiration date according to a sixth embodiment of the present invention;

FIG. 15 is a perspective view of an apparatus for warning of an expiration date according to a seventh embodiment of the present invention;

FIG. 16 is a perspective view of a bottle used with the apparatus for warning of an expiration date shown in FIG. 15;

FIG. 17 is an exploded view of an apparatus for warning of an expiration date according to an eighth embodiment of the present invention; and

FIG. 18 is a flow chart of a process executed in the apparatus for warning of an expiration date shown in FIG. 17.

### DETAILED DESCRIPTION OF PREFERRED EMBODIMENT

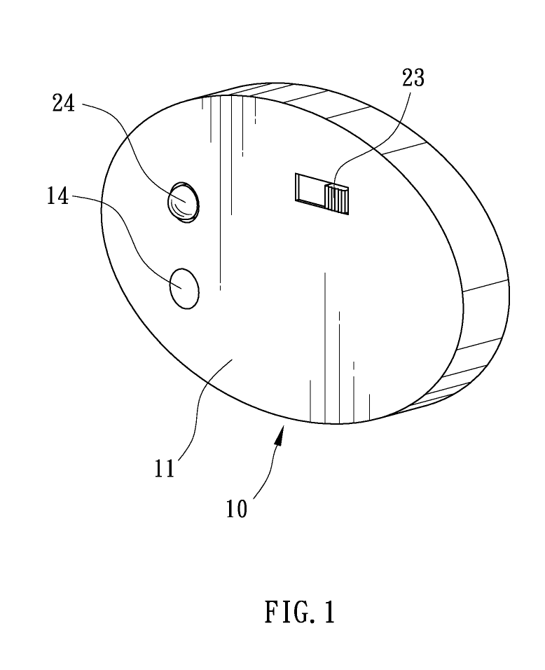

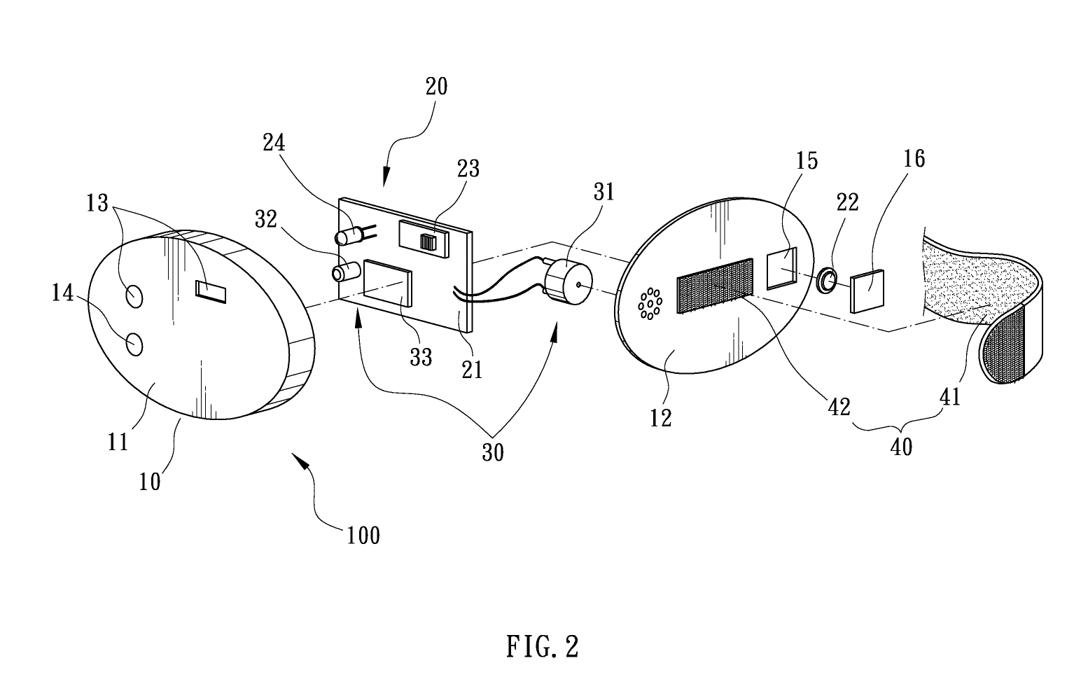

Referring to FIGS. 1 and 2, an apparatus 100 for warning of an expiration date includes a casing 10, a processing unit 20 and an attachment unit 40 according to a first embodiment of the present invention. The casing 10 includes a front shell 11 attached to a rear shell 12. The front shell 11 includes apertures 13 defined therein. One of the apertures 13 is covered by a lens 14. The rear shell 12 includes an opening 15 defined therein. The opening 15 can be covered by a cover 16.

The processing unit 20 includes a circuit board 21, a power supply unit 22, a switch 23, a light 24, a speaker 31, a Bluetooth transmitter 32 and a Bluetooth module 33. The switch 23, the light 24, the speaker 31, the Bluetooth transmitter 32 and the Bluetooth module 33 are electrically connected to the circuit board 21.

The circuit board 21 is located in the casing 10 so that access to the switch 23 is allowed through one of the apertures 13. The light 24 is visible through another one of the apertures 13. The Bluetooth transmitter 32 is aligned with the other aperture 13, which is covered by the lens 14.

The power supply unit 22 is preferably a battery that can be located in the casing 10 through the opening 15. The power supply unit 22 can be electrically connected to the circuit board 21 to energize the other electric or electronic elements. The light 24 shows the energy level in the power supply unit 22. Light emitted from the light 24 is stronger as the energy level in the power supply unit 22 is higher. Thus, from the intensity of the light emitted from the light 24, a user knows when to replace the battery with a new one. Moreover, the light 24 emits makes sound when the expiration date is reached. The light 24 is preferably a SMT light-emitting diode.

Data corresponding to various expiration dates are set in the processing unit 20 when the apparatus 100 is made. The expiration dates can be 12, 24, 36 or 48 hours or any other periods of time. The user operates the switch 23 to choose from these expiration dates.

The speaker 31 makes sound when the expiration date is reached. It is preferred that the speaker 31 continues to make sound. The speaker 31 is preferably a beeper.

The Bluetooth transmitter 32 may be used with a Bluetooth receiver (not shown) located in the exterior of the refrigerator B. The Bluetooth receiver may be electrically connected to an indication device also located in the exterior of the refrigerator B. Thus, the Bluetooth transmitter 32 can send a signal to the Bluetooth receiver. On receiving the signal, the Bluetooth receiver instructs the indication device to provide words, patterns, vibration, light or sound to get the user's attention. The Bluetooth receiver and the indication device may be merged in an RFID apparatus, a personal digital assistant or a personal computer.

Bluetooth is one of various radio transmission techniques. FHSS is used in Bluetooth at a frequency of about 1600 times/sec. The Bluetooth transmitter 32 can be used with one Bluetooth receiver or more. Generally, the maximum distance for the transmission of a Bluetooth signal is about 10 meters. The maximum distance can however be increased a range from 50 to 100 meters if the power is increased. It is difficult to intercept or interfere with Bluetooth signals.

The attachment unit 40 includes a Velcro device 42 (or “hook-and-loop means”) provided on a belt 41. The Velcro device 42 includes two hook-based portions and a loop-based portion. One of the hook-based portions is attached to the rear shell 12 by adhesion for example. The other hook-based portion is attached to a side of the belt 41 by sewing for example. The loop-based portion is attached to an opposite side of the belt 41 by sewing for example.

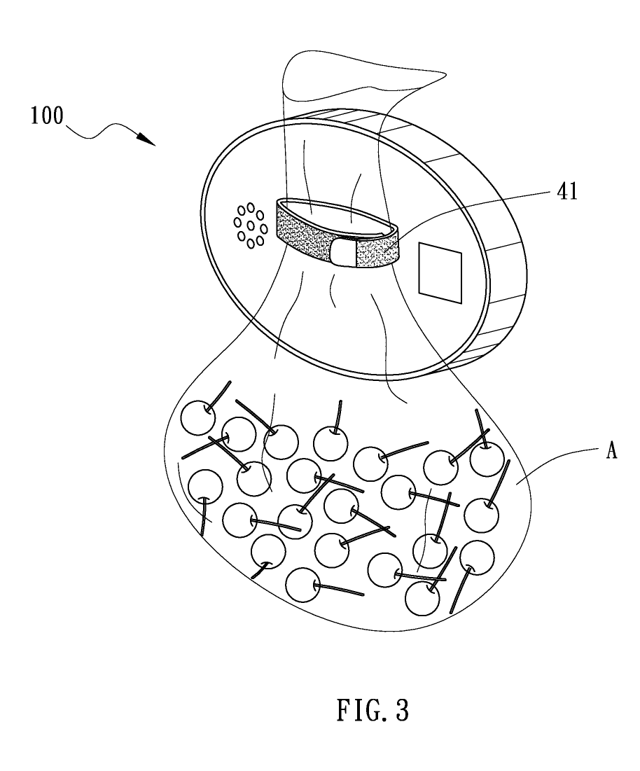

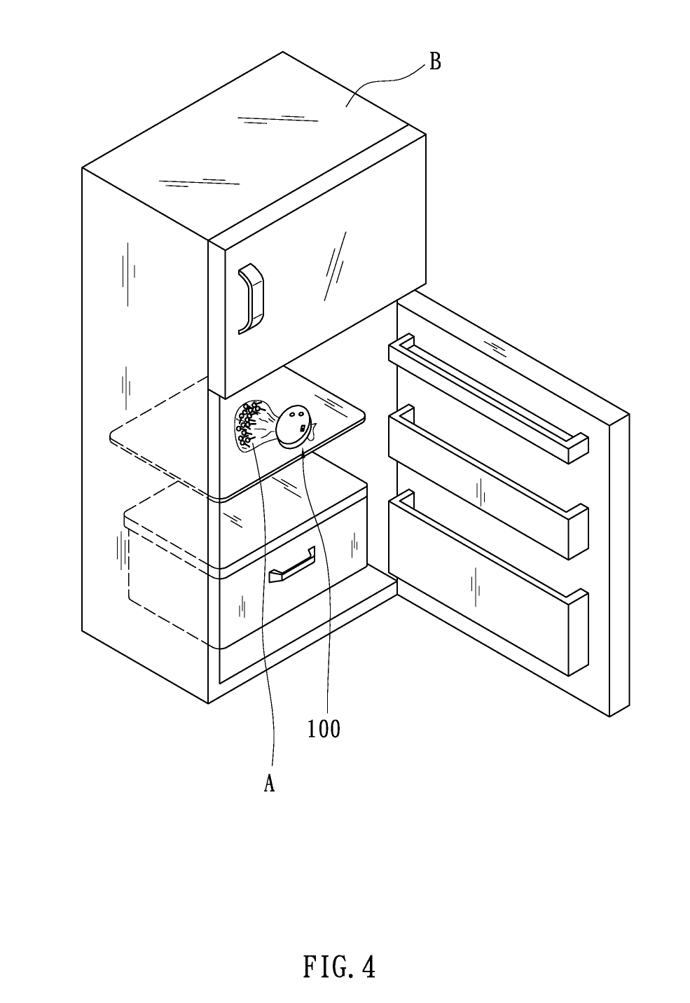

Referring to FIG. 3, food such as vegetable, grain, cookies, sweet, bakery and candy is located in a bag A. The bag A is tied with the belt 41 that is retained in a loop by the Velcro device 42. Referring to FIG. 4, the food contained in the bag A tied by the belt 41 attached to the apparatus 100 is located in a refrigerator B. Thus, the apparatus 100 is used to specifically warn of the expiration date of a certain batch of food. The apparatus 100 can be used anywhere.

The apparatus 100 is turned on, and the expiration date is set to be 48 hours for example. When the expiration date is reached, the speaker 31 begins to make sound. Synchronously, the Bluetooth transmitter 32 transmits a signal to the Bluetooth receiver. An additional piece of equipment may be connected to the Bluetooth receiver to provide words, patterns, vibration, light or sound to get the user's attention. Thus, the user knows that it is time to use, dispose of or recycle the food. Of course, the apparatus 100 may be used for medicine as well.

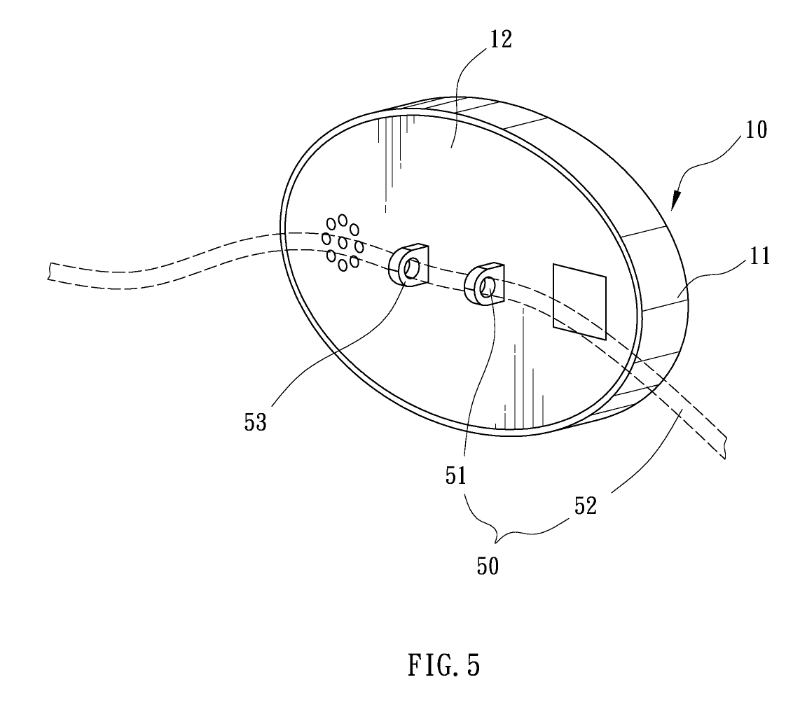

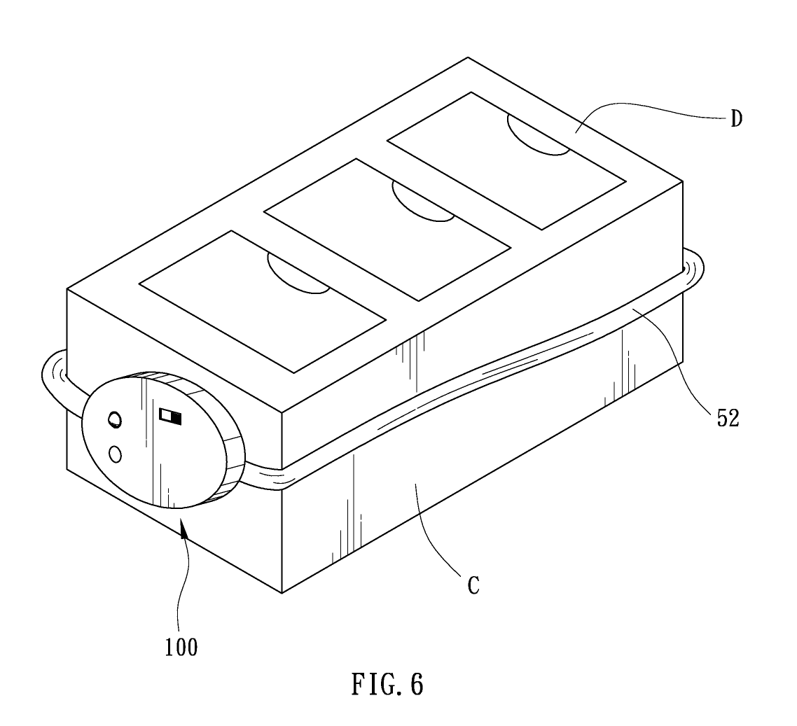

Referring to FIGS. 5 and 6, there is shown an apparatus 100 according to a second embodiment of the present invention. The second embodiment is like the first embodiment except including an attachment unit 50 instead of the attachment unit 40. The attachment unit 50 includes two ears 53 formed on the rear shell 12 and a rope 52 inserted through an aperture 51 defined in each of the ears 53. The apparatus 100 may be attached to a case C by tying the rope 52 on the case C. The case C includes drawers D for containing various things with similar or identical expiration dates. The case C may be located in the refrigerator B or on a table.

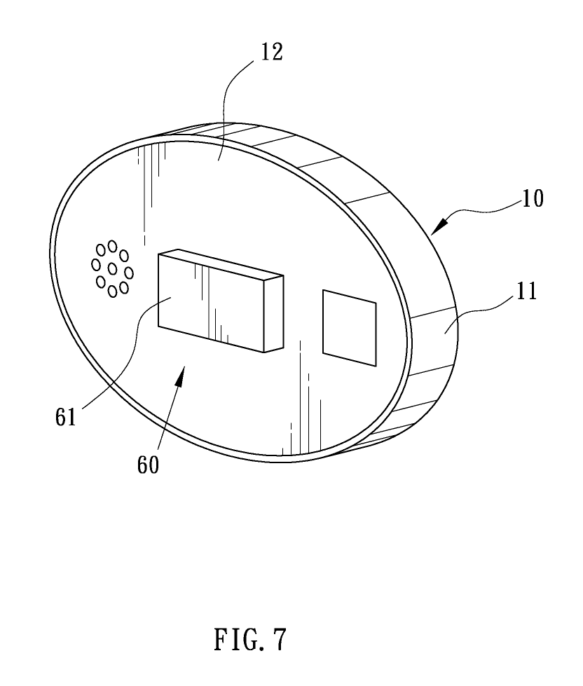

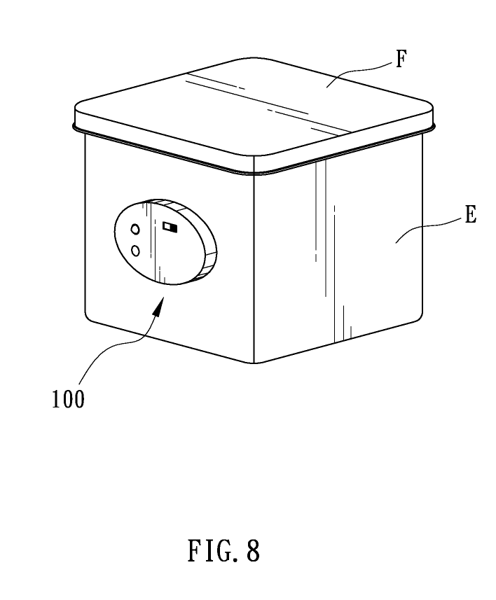

Referring to FIGS. 7 and 8, there is shown an apparatus 100 according to a third embodiment of the present invention. The third embodiment is like the first embodiment except including an attachment unit 60 instead of the attachment unit 40. The attachment unit 60 includes a magnet 61 embedded or fit in the rear shell 12 or attached to the rear shell 12 by adhesion. The apparatus 100 may be attached to a ferromagnetic case E by magnetically attaching the magnet 61 to the ferromagnetic case E. The ferromagnetic case E is equipped with a lid F. Tin in the form of liquid may be located in the ferromagnetic case E before the ferromagnetic case E is located in the refrigerator B. The apparatus 100 warns the user of the expiration date so that the user can use the tin in time before the tin deteriorates. Thus, the user does not have to dispose of the precious tin.

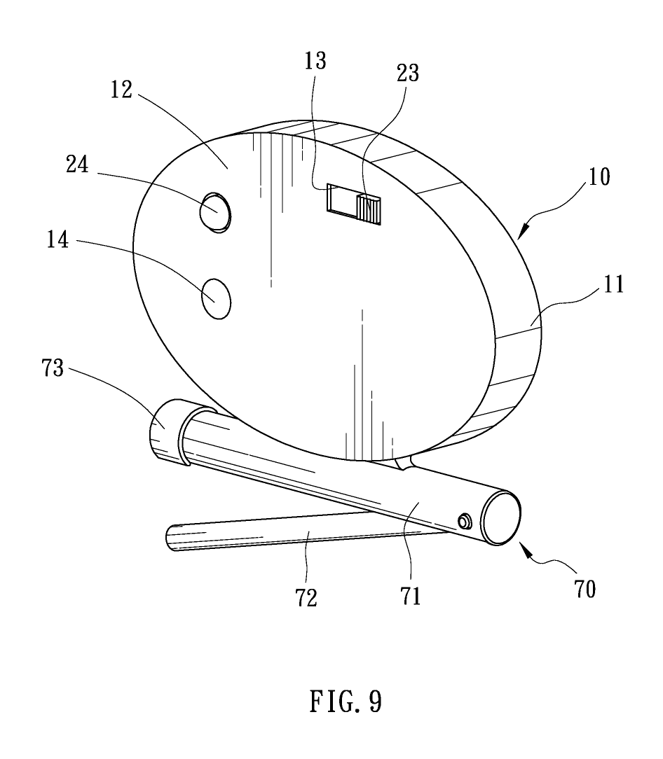

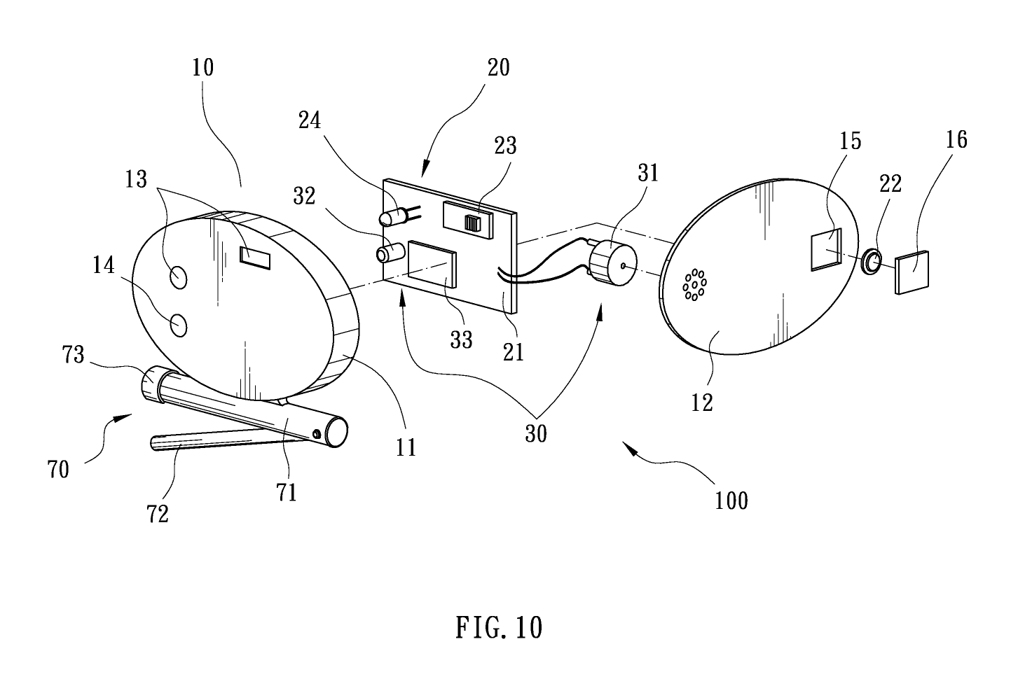

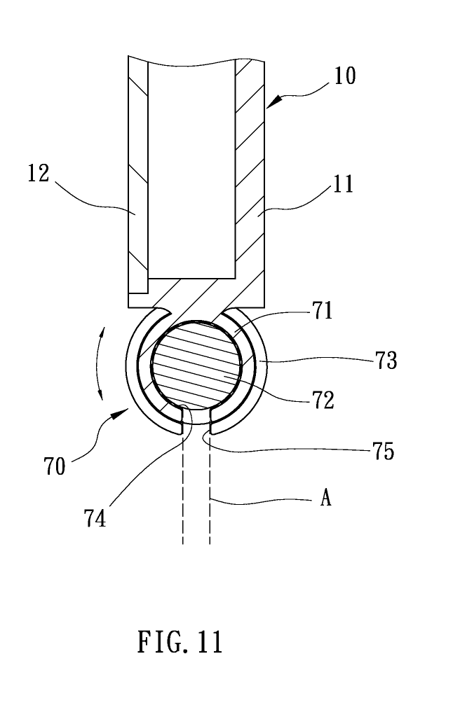

Referring to FIGS. 9 through 11, there is shown an apparatus 100 according to a fourth embodiment of the present invention. The fourth embodiment is like the first embodiment except including a clamping unit 70 instead of the attachment unit 40. The clamping unit 70 includes a sheath 71 attached to the front shell 11, a rod 72 pivotally connected to the sheath 71, and a lock 73 rotationally connected to the sheath 71. The sheath 71 includes a groove 74 defined therein along a length. The rod 72 is made with a circular cross-sectional shape. The lock 73 is a C-shaped element including a gap 75 defined therein. An end of the rod 72 is pivotally connected to an end of the sheath 71. The lock 73 is rotationally located on an opposite end of the sheath 71.

In operation, a portion of the bag A is located between the sheath 71 and the rod 72. The lock 73 is located in an angular position relative to the sheath 71 where the gap 75 is aligned with the groove 74. The rod 72 is located in the groove 74 through the gap 75. The bag A is clamped by the clamping unit 70. The lock 73 is rotated to another angular position relative to the sheath 71 where the gap 75 is not aligned with the groove 74. Thus, the clamping of the bag A by the clamping unit 70 is retained. The bag A and the apparatus 100 may be located in the refrigerator B.

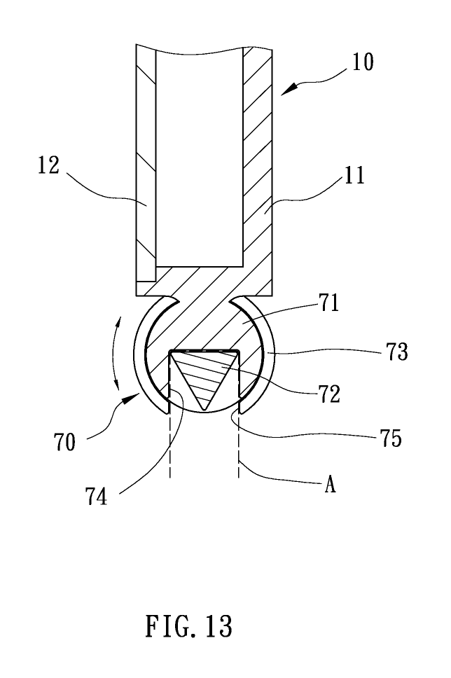

Referring to FIG. 13, there is shown an apparatus 100 according to a fifth embodiment of the present invention. The fifth embodiment is like the first embodiment except that the rod 72 is made with a triangular cross-sectional shape instead of the circular cross-sectional shape.

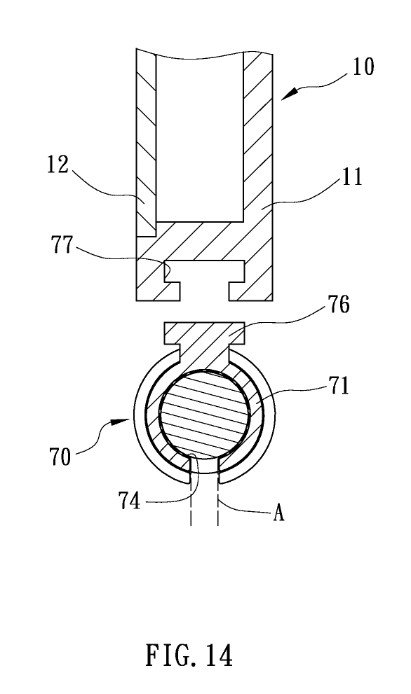

Referring to FIG. 14, there is shown an apparatus 100 according to a sixth embodiment of the present invention. The sixth embodiment is like the fifth embodiment except that the clamping unit 70 includes a dovetail 76 formed on the sheath 71 along the length and a dovetail groove 77 defined in the front shell 11. The clamping unit 70 may be attached to the front shell 11 by inserting the dovetail 76 into the dovetail groove 77. The clamping unit 70 may be detached from the front shell 11 by removing the dovetail 76 from the dovetail groove 77.

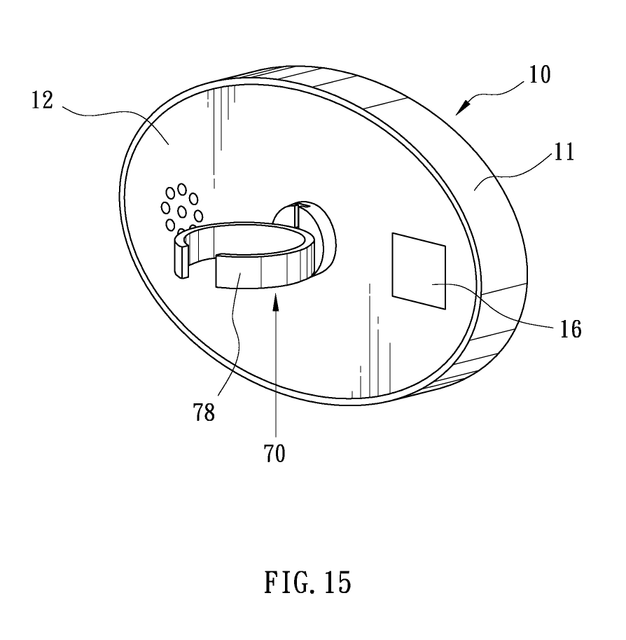

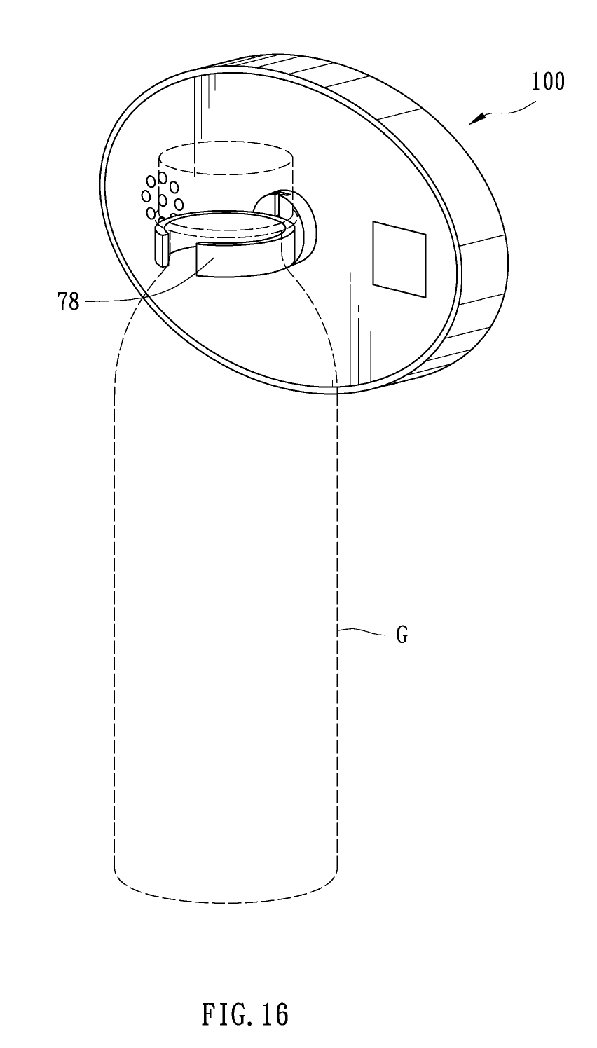

Referring to FIGS. 15 and 16, there is shown an apparatus 100 according to a seventh embodiment of the present invention. The seventh embodiment is like the sixth embodiment except that the clamping unit 70 includes a C-clip 78 instead of the sheath 71, the rod 72 and the lock 73. The apparatus 100 for warning of an expiration date may be attached to a bottle G by providing the C-clip 78 on a bottleneck of the bottle G.

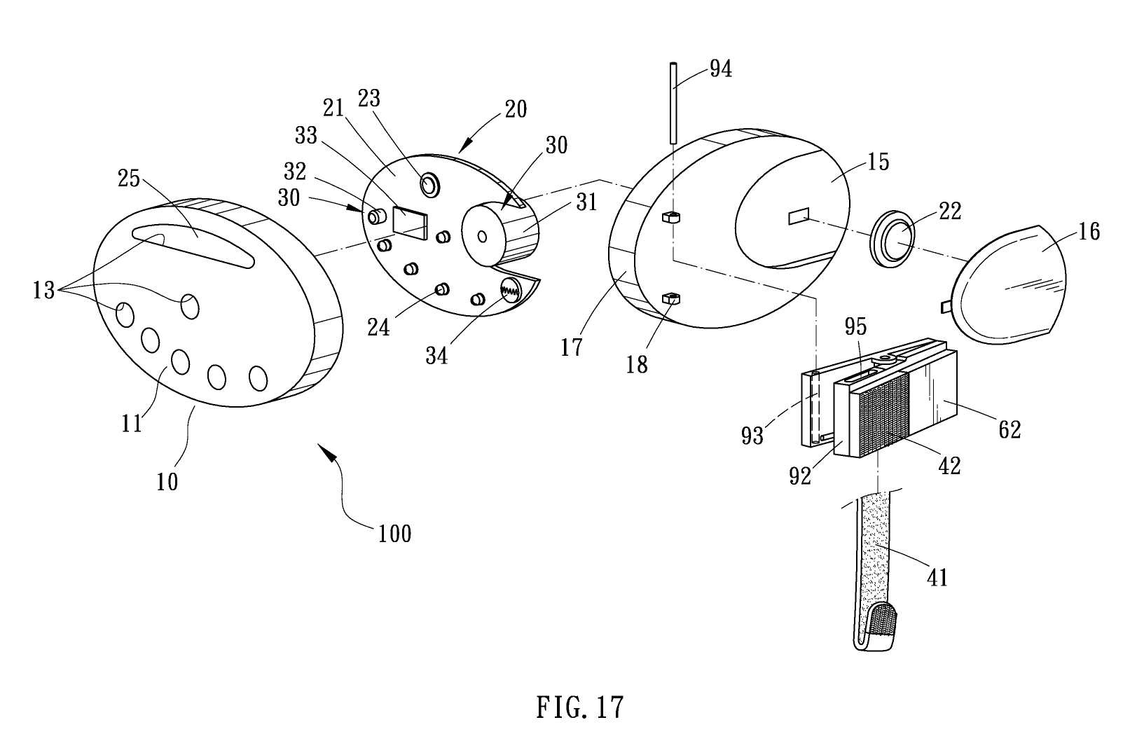

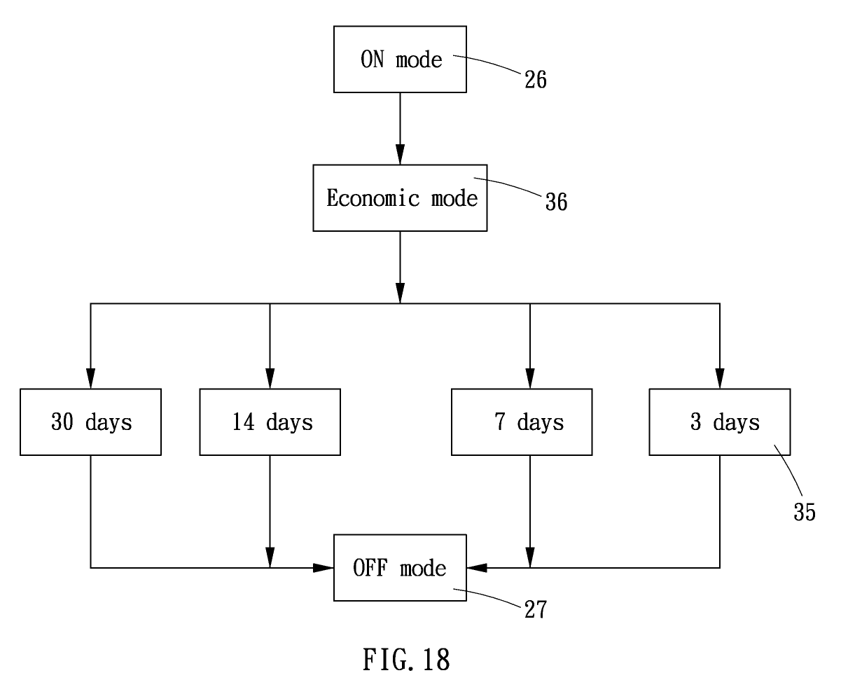

Referring to FIGS. 17 and 18, there is shown an apparatus 100 according to an eighth embodiment of the present invention. The eighth embodiment is like the first embodiment except several things. At first, the front shell 11 includes more apertures 13. One of the apertures 13 is a slot covered by a flexible cover 25.

Secondly, the switch 23 is in the form of a button located behind the flexible cover 25. Thus, the switch 23 can be pushed through the flexible cover 25. The switch 23 is operable to select from various expiration dates.

Thirdly, the processing unit 20 includes more lights 24. Each of the lights 24 represents one of the expiration dates. Each of the lights 24 is visible through a related one of the apertures 13.

Fourthly, the processing unit includes an additional photo sensor 34. On detecting light, the photo sensor 34 turns the processing unit 20 into an active mode. Otherwise, the photo sensor 34 turns the processing unit 20 into an idle mode.

Fifthly, there is provided a rear shell 17 instead of the rear shell 12. The rear shell 17 is shaped like the front shell 11. Two ears 18 are formed on the rear shell 17. Each of the ears 18 includes an aperture defined therein.

Sixthly, there is provided a clip 92 between the attachment unit 40 and the rear shell 17. The clip 92 is pivotally connected to the rear shell 17 by inserting a pin 94 in the apertures of the ears 18 and a tunnel 93 defined in a first jaw of the clip 92. The belt 41 is inserted through a slot 95 defined in a second jaw of the clip 92. One of the hook-based portions of the Velcro device 42 is attached to the second jaw of the clip 92. The other hook-based portion of the Velcro device 42 is attached to a side of the belt 41. The loop-based portion of the Velcro device 42 is attached to another side of the belt 41. Thus, the apparatus 100 may be attached to the bag A for example tying the belt 41 on the bag A.

Seventhly, a magnet 62 is attached to the second jaw of the clip 92. Thus, the apparatus 100 may be attached to the ferromagnetic case E for example by magnetically attaching the magnet 62 to ferromagnetic case E.

The switch 23 is operable to turn the apparatus 100 between an ON mode 26 and an OFF mode 27. In the ON mode, the photo sensor 34 turns on and off an economic mode 36. In a selection mode 35, there are provided various expiration dates such as 3, 7, 14 and 30 days. One of the expiration dates may be selected.

On detecting light, the photo sensor 34 stops the economic mode 36. In the economic mode 36, the lights 24 emit light when the selected one of the expiration dates is reached. Furthermore, the speaker 31 makes sound periodically. The period of time between two rounds of the making of the sound is short.

Without detecting any light, the photo sensor 34 starts the economic mode. In the economic mode 36, the lights 24 do not emit light when the selected one of the expiration dates is reached. The speaker 31 still makes sound periodically. However, the period of time between two rounds of the making of the sound is extended.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for warning of an expiration date including:
a casing;
a processing unit located in the casing, wherein the processing unit includes a power supply unit, a switch and a warning unit electrically connected to one another, wherein the warning unit warns a user of the expiration date of an object when the expiration date is reached; and
an attachment unit connected to the casing, wherein the attachment unit can be detachably attached to the object.

2. The apparatus for warning of an expiration date according to claim 1, wherein the attachment unit includes a belt connected to the casing for tying the object and a Velcro device provided on the belt for retaining the belt as a loop.

3. The apparatus for warning of an expiration date according to claim 1, wherein the attachment unit includes a rope directed through two apertures defined in the casing.

4. The apparatus for warning of an expiration date according to claim 1, wherein the attachment unit includes a magnet connected to the casing.

5. An apparatus for warning of an expiration date including:
a casing;
a processing unit located in the casing, wherein the processing unit includes a power supply unit, a switch and a warning unit electrically connected to one another, wherein the warning unit warns a user of the expiration date of an object when the expiration date is reached; and
a clamping unit connected to the casing for clamping the object.

6. The apparatus for warning of an expiration date according to claim 5, wherein the clamping unit includes:
a sheath connected to the casing, wherein the sheath includes a groove defined therein;
a rod pivotally connected to the sheath so that the rod can be located in and outside the groove; and
a lock rotationally connected to the sheath, wherein the lock includes a gap aligned with the groove when the lock is in a releasing position.

7. The apparatus for warning of an expiration date according to claim 6, wherein the sheath and the casing are made one.

8. The apparatus for warning of an expiration date according to claim 6, wherein the sheath and the casing are made separately.

9. The apparatus for warning of an expiration date according to claim 6, wherein the rod includes a cross-sectional shape selected from the group consisting of a circle and a triangle.

10. The apparatus for warning of an expiration date according to claim 5, wherein the clamping unit includes a C-clip connected to the casing.

11. The apparatus for warning of an expiration date according to claim 5, wherein the clamping unit includes a C-clip formed with a dovetail movably inserted in a dovetail groove defined in the casing.

12. An apparatus for warning of an expiration date including:
a casing; and
a processing unit located in the casing, wherein the processing unit includes a power supply unit, a switch, a warning unit and a sensor electrically connected to one another, wherein the warning unit warns a user of the expiration date of an object when the expiration date is reached, wherein the sensor turns the processing unit into an economic mode from a normal mode when it senses it senses a predetermined situation.

13. The apparatus for warning of an expiration date according to claim 12, further including a clip connected to the casing.

14. The apparatus for warning of an expiration date according to claim 13, further including a belt connected to the clip.

15. The apparatus for warning of an expiration date according to claim 14, further including a Velcro device connected to the belt.

16. The apparatus for warning of an expiration date according to claim 14, further including a magnet connected to the clip.

17. The apparatus for warning of an expiration date according to claim 12, wherein the speaker is a beeper.

18. The apparatus for warning of an expiration date according to claim 12, wherein the warning unit includes a Bluetooth transmitter.

19. The apparatus for warning of an expiration date according to claim 12, wherein the warning unit includes at least one light.

20. The apparatus for warning of an expiration date according to claim 12, wherein the sensor is a photo sensor that initiates the economic mode when it senses no light and initiates the normal mode when it senses light.
